(19) United States
(12) Patent Application Publication
(10) Pub. No.: US 2007/0224377 A1
(43) Pub. Date: Sep. 27, 2007

(54) Molding of Thermoplastic Polyesters

(75) Inventors: Roland Johannes Leimbacher, Einsiedeln (CH); Anthony Nicholas Sammut, Norden (GB); Mark Peter Kearns, Banbridge (GB); Mark Peter McCourt, Newry (GB)

Correspondence Address: ERIC D. MIDDLEMAS;EASTMAN CHEMICAL COMPANY, P. O. BOX 511, KINGSPORT, TN, 37662-5075, US

(73) Assignee: EASTMAN CHEMICAL COMPANY, KINGSPORT, TN (US)

(21) Appl. No.: 11/574,355

(22) PCT Filed: Aug. 31, 2005
(86) PCT No.: PCT/GB05/03368

§ 371 Date: Mar. 9, 2007

(30) Foreign Application Priority Data
Aug. 31, 2004 (GB) 0419323.1

(51) Int. Cl. B29C 41/00; B29C 41/04; B29C 67/00; B29L 22/00; C08L 67/02

(52) U.S. Cl. 428/36.92; 264/310

(57) ABSTRACT

Disclosed are processes for rotational molding of thermoplastic polyesters and for hollow articles produced therefrom. The thermoplastic polyesters have a crystallization half time of at least 10 minutes and an inherent viscosity of 0.55 to 0.70 dL/g. Additional thermoplastic polymers may be used to produce multilayered articles.

### FIELD OF THE INVENTION

This invention pertains to a process for rotational molding of thermoplastic polyesters and the hollow articles produced therefrom. More specifically, this invention pertains to a process for rotational molding of thermoplastic polyesters having a crystallization half time of at least 10 minutes and an inherent viscosity of 0.55 to 0.70 dL/g.

### BACKGROUND OF THE INVENTION

Rotational molding is a manufacturing method used for producing hollow, plastic articles. Typical rotational molding processes utilize high temperatures, low-pressures, and biaxial rotation, to produce hollow, one-piece parts. Significant centrifugal forces are not involved. Although rotational molding is particularly suited to producing hollow articles, the technique can provide shaped articles that compete effectively with other molding and extrusion processes, in particular, with extrusion blow molding. Rotational molding differs from all other processing methods in that the heating, melting, shaping, and cooling stages all occur after the polymer is placed in the mold. In addition, no external pressure is used to force the molten polymer into the mold. Rotational molded products are essentially stress-free, have no weld lines, and can be produced in complex shapes. In addition, mold costs are relatively low, which allows large articles to be produced economically.

Typical applications of rotational molded articles are toys, various types of tanks, containers, boxes, ducts, road furniture, bumbers, display parts, light globes, etc. A general description of the rotational molding process and its applications is given, for example, in J. Titus, “Rotational Moulding of Plastic Powders”, AMC Engineering Design Handbook No. 706-312, April 1975, Chapters 1-10, and in Glenn L. Beall, Rotational Molding—Design, Materials, Tooling, and Processing, Carl Hanser Verlag, 1998.

The number of polymeric materials which may be used in rotational molding process, however, are limited. The most widely used polymer is poly(ethylene), especially medium density poly(ethylene). Other polymers which may be rotationally molded include poly(propylene), poly(vinylchloride) and, to a lesser extent, polyamides (i.e., nylons), poly(ethylene-co-vinylacetate), and polycarbonate. Small volumes of acrylonitrile-butadiene-styrene, acetal, acrylic, cellulosics, epoxy fluorocarbons, ionomers, phenolic and polybutylene, polystyrene, and silicone also have been used in specific, limited applications. Although the rotational molding of polyester polymers has been disclosed such as, for example, in Japan Patent Application No.'s 49-59172; 49-45955; 50-145475; 2000-167855; U.K. Patent No. 1 416 388; U.S. Pat. No. 3,966,870; P. Taylor, “Rotomolding”, British Plastics and Rubber, February 1986, pp. 22-27; and Rangarajan et al., “Studies on the Rotomolding of Liquid Crystalline Polymers”, ANTEC 2001, pp. 1286-1290; the rotationally molded articles from thermoplastic polyesters frequently exhibit unsatisfactory chemical and physical properties and/or utilitize expensive, specialty polymers. Lower cost thermoplastic, polyesters polymers such as, for example, poly(ethylene) terephthalate, often crystallize under typical rotational molding conditions and thus fail to coat the inside of the mold in a uniform manner. One approach to this problem is addressed by using thermoset polyesters or polyester prepolymers in which all or at least part of the polymerization reaction to form the final polymer is carried out within the mold. In another approach, the polyester is blended with or used in combination with another thermoplastic polymer such as, for example, a polyolefin or polycarbonate, to form a multilayered article. Such processes, however, are expensive to operate and produce articles lacking a combination of desirable properties such as, for example, clarity, high impact strength, and flexibility. In another approach, elastomeric polyester block copolymers have been used in rotational molding processes. Such polyester block-copolymers are partially crystalline, have low modulus, and are not suited to make transparent, clear, and stiff articles such as light globes or display parts. Thus, there is a need in the art for an economical process for the rotational molding of low cost, thermoplastic polyester polymers to provide hollow articles with satisfactory physical properties that avoids the problems noted hereinabove.

### SUMMARY OF THE INVENTION

We have discovered that thermoplastic polyesters having a specified range of inherent viscosity and which do not crystallize while being processed may be rotationally molded to produce hollow articles of various dimensions and shapes. Thus, our invention provides a process for rotational molding, comprising:
(a) introducing a thermoplastic polyester into a mold, wherein said polyester is a random copolymer having a crystallization half time of at least 10 minutes and an inherent viscosity of 0.55 to 0.70 deciliters/gram (dL/g), wherein said crystallization half time is measured from the molten state using a differential scanning calorimeter (DSC) by heating a 15.0 mg sample of said polyester in an aluminum pan to 290° C. at a rate of 320° C. per minute for 2 minutes, cooling said sample to the isothermal crystallization temperature at a rate of 320° C. per minute in the presence of helium and determining the time span from reaching the isothermal crystallization temperature to the point of a crystallization peak on the DSC curve; and
(b) rotating said mold at a peak internal air temperature of 150 to 255° C.
   The polyesters useful in our invention have a crystallization half-time of at least 10 minutes and may comprise a variety of diacid and diol residues such as, for example, terephthalic acid, isophthalic acid, 1,4-cyclohexanedimethanol, and/or diethylene glycol. Various mold release additives, chain extenders, and other additives may be used to enhance our rotational molding process or to modify the properties of the molded article as needed for a particular application. Additional thermoplastic polymers may be used in our process to produce multilayered articles. The instant invention, therefore, also provides for the economical production of hollow, polyester articles having good clarity, high impact strength, and flexibility. Accordingly, another aspect of our invention is a hollow article, comprising:
(a) a thermoplastic polyester having a crystallization half time from a molten state of at least 15 minutes and an inherent viscosity of 0.55 to 0.70 dL/g, wherein said crystallization half time is measured from the molten state using a differential scanning calorimeter (DSC) by heating a 15.0 mg sample of said polyester in an aluminum pan to 290° C. at a rate of 320° C. per minute for 2 minutes, cooling said sample to the isothermal crystallization temperature at a rate of 320° C. per minute in the presence of helium and determining the time span from reaching the isothermal crystallization temperature to the point of a crystallization peak on the DSC curve, and wherein said polyester is a random copolymer comprising
   (i) diacid residues comprising at least 90 mole percent, based on the total moles of diacid residues, of one or more residues of: terephthalic acid, naphthalenedicarboxylic acid, 1,4-cyclohexanedicarboxylic acid, or isophthalic acid; and
   (ii) diol residues comprising 10 to 100 mole percent, based on the total moles of diol residues, of one or more residues of: 1,4-cyclohexanedimethanol, neopentyl glycol, or diethylene glycol; and 0 to 90 mole percent of one or more residues of diols selected from ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol;

wherein said hollow article is prepared by a rotational molding process.

### DETAILED DESCRIPTION

Certain amorphous polyesters may be rotationally molded to produce shaped, transparent hollow articles having a wall thickness typically of 1-15 mm. The polyesters of the process of the invention have a crystallization rate which allows processing in rotational molding equipment to occur without crystallization of the polyester. Our novel process for rotational molding thus comprises: (a) introducing a thermoplastic polyester into a mold, wherein said polyester is a random copolymer having a crystallization half time of at least 10 minutes and an inherent viscosity of 0.55 to 0.70 deciliters/gram (dL/g), wherein the crystallization half time is measured from the molten state using a differential scanning calorimeter (DSC) by heating a 15.0 mg sample of said polyester in an aluminum pan to 290° C. at a rate of 320° C. per minute for 2 minutes, cooling said sample to the isothermal crystallization temperature at a rate of 320° C. per minute in the presence of helium and determining the time span from reaching the isothermal crystallization temperature to the point of a crystallization peak on the DSC curve; and (b) rotating the mold at a peak internal air temperature of 150 to 255° C. The hollow articles produced by the process of the invention have excellent gloss and transparency and can be used in a numerous applications such as, for example, toys, display parts, light globes, medical parts, automotive, food, and chemical containers. These articles may be printed with a variety of inks or undergo other post-treatments by use of welding or other joining techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Our invention is a process for rotational molding of polyesters. The term “rotational molding”, as used herein, is intended to be synonymous with “rotomolding”, “rotary molding”, “rotational casting”, or “spin molding” and refers to the method of forming objects from a liquid or powdered thermoplastic or thermoset resin in which the resin is charged into a hollow mold and then rotated continuously in a uniaxial or biaxial mode at a high temperature to form hollow complex parts. As the mold is heated, the mold is typically rotated along two or three axes at a low speed. The heat melts the plastic resin inside the mold and melted resin coats the interior surface of the mold. The mold is then gradually cooled and the re-solidified plastic resin, which has assumed the shape of the interior walls of the mold, is removed from the mold.

The term “polyester”, as used herein, is intended to include “copolyesters” and is understood to mean a synthetic polymer prepared by the polycondensation of one or more difunctional carboxylic acids with one or more difunctional hydroxyl compounds. The polyesters of the present invention are “thermoplastic”, meaning that the polyester softens and/or melts when exposed to heat and returns to its original condition when cooled to room temperature. The polyesters of the invention, therefore, are not “thermoset” polyesters, which means that the polyester solidifies or “sets” irreversibly when heated. In contrast to thermoplastic polyesters, thermoset polyesters typically are highly cross-linked. The cross-linking reaction or “curing” may be induced various means such as, for example, heat, chemical cross-linking agents, or radiation. The difunctional carboxylic acid, typically, is a dicarboxylic acid and the difunctional hydroxyl compound is a dihydric alcohol such as, for example, glycols and diols. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue”, as used herein, means any organic structure incorporated into a polymer or plasticizer through a polycondensation reaction involving the corresponding monomer. The term “repeating unit”, as used herein, means an organic structure having a dicarboxylic acid residue and a diol residue bonded through a carbonyloxy group. Thus, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a high molecular weight polyester.

The polyester compositions of present invention are prepared from polyesters comprising dicarboxylic acid residues, diol residues and, optionally, branching monomer residues. The polyesters of the present invention contain substantially equal molar proportions of acid residues (100 mole %) and diol residues (100 mole %) which react in substantially equal proportions such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % ethylene glycol, based on the total diol residues, means the polyester contains 30 mole % ethylene glycol residues out of a total of 100 mole % diol residues. Thus, there are 30 moles of ethylene glycol residues among every 100 moles of diol residues.

The polyesters of this invention have a crystallization half time from a molten state of at least 10 minutes. The crystallization half time may be, for example, at least 12 minutes, at least 15 minutes, at least 20 minutes, at least 30 minutes, and at least 60 minutes. Typically, polyesters exhibiting a crystallization half time of at least 10 minutes are copolyesters or random copolymers. The term “random copolymer”, as used herein, means that the polyester comprises more than one diol and/or diacid residues in which the different diol or diacid residues are randomly distributed along the polymer chain. Thus, the polyesters of the instant invention are not “block copolymers” as would be understood by persons of skill in the art. Typically, the polyesters have a substantially amorphous morphology, meaning that the polyesters comprise substantially unordered regions of polymer. Amorphous or semicrystalline polymers typically exhibit either only a glass transition temperature (abbreviated herein as “Tg”) alone or a glass transition temperature in addition to a melting point (abbreviated herein as “Tm”), as measured by well-known techniques such as, for example, differential scanning calorimetry (“DSC”). The desired crystallization kinetics from the melt also may be achieved by the addition of polymeric additives such as, for example, plasticizers, or by altering the molecular weight characteristics of the polymer. The polyesters of the invention also may be a miscible blend of a substantially amorphous polyester with a more crystalline polyester, combined in the proportions necessary to achieve a crystallization half time of at least 10 minutes. In another embodiment, however, the polyesters of our invention are not blends.

The crystallization half time of the polyester, as used herein, may be measured using methods well-known to persons of skill in the art. For example, the crystallization half time may be measured using a Perkin-Elmer Model DSC-2 differential scanning calorimeter. The crystallization half time is measured from the molten state using the following procedure: a 15.0 mg sample of the polyester is sealed in an aluminum pan and heated to 290° C. at a rate of 320° C./min for 2 minutes. The sample is then cooled immediately to the predetermined isothermal crystallization temperature at a rate of 320° C./minute in the presence of helium. The isothermal crystallization temperature is the temperature between the glass transition temperature and the melting temperature that gives the highest rate of crystallization. The isothermal crystallization temperature is described, for example, in Elias, H. Macromolecules, Plenum Press: NY, 1977, p 391. The crystallization half time is determined as the time span from reaching the isothermal crystallization temperature to the point of a crystallization peak on the DSC curve.

The diacid residues of the polyester comprise at least 80 mole percent (mole %), based on the total moles of diacid residues, of one or more residues of terephthalic acid, naphthalenedicarboxylic acid, 1,4-cyclohexanedicarboxylic acid, or isophthalic acid. Any of the various isomers of naphthalenedicarboxylic acid or mixtures of isomers may be used, but the 1,4-, 1,5-, 2,6-, and 2,7-isomers are preferred. Cyclo-aliphatic dicarboxylic acids such as, for example, 1,4-cyclohexanedicarboxylic acid may be present at the pure cis or trans isomer or as a mixture of cis and trans isomers. For example, the polyester may comprise 80 to 100 mole % of diacid residues from terephthalic acid and 0 to 20 mole % diacid residues from isophthalic acid.

The polyester also contains diol residues that may comprise 10 to 100 mole %, based on the total moles of diol residues, of the residues of 1,4-cyclohexanedimethanol, neopentyl glycol, or diethylene glycol; and 0 to 90 mole % of the residues of one or more diols containing 2 to 20 carbon atoms such as, for example, ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol. As used herein, the term “diol” is synonymous with the term “glycol” and means any dihydric alcohol. For example, the diol residues also may comprise 10 to 100 mole percent, based on the total moles of diol residues, of the residues of 1,4-cyclohexanedimethanol and 0 to 90 mole percent of the residues of one or more diols selected from 1,5-pentanediol, 1,6-hexanediol, 1,8-octanediol, 2,2,4-trimethyl-1,3-pentanediol, 1,3-propanediol, and the like. Further examples of diols that may be used in the polyesters of our invention are triethylene glycol; polyethylene glycols; 2,4-dimethyl-2-ethylhexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,5-pentanediol; thiodiethanol; 1,2-cyclohexanedimethanol; 1,3-cyclohexanedimethanol; p-xylylenediol; bisphenol S; or combinations of one or more of these glycols. The cycloaliphatic diols, for example, 1,3- and 1,4-cyclohexane-dimethanol, may be present as their pure cis or trans isomers or as a mixture of cis and trans isomers. In another example, the diol residues may comprise 10 to 100 mole percent of the residues of 1,4-cyclohexanedimethanol and 0 to 90 mole % of the residues of ethylene glycol. In a further example, the diol residues may comprise 20 to 80 mole percent of the residues of 1,4-cyclohexanedimethanol and 20 to 80 mole percent of the residues of ethylene glycol. In another example, the diol residues may comprise 20 to 70 mole percent of the residues of 1,4-cyclohexanedimethanol and 80 to 30 mole percent of the residues of ethylene glycol. In yet another example, the diol residues may comprise 20 to 65 mole percent of the residues of 1,4-cyclohexanedimethanol and the diacid residues 95 to 100 mole percent of the residues of terephthalic acid.

The polyester also may further comprise from 0 to 20 mole percent of the residues of one or more modifying diacids containing 4 to 40 carbon atoms. Examples of modifying dicarboxylic acids that may be used include aliphatic dicarboxylic acids, alicyclic dicarboxylic acids, aromatic dicarboxylic acids, or mixtures of two or more of these acids. Specific examples of modifying dicarboxylic acids include, but are not limited to, one or more of succinic acid, glutaric acid, adipic acid, suberic acid, sebacic acid, azelaic acid, dimer acid, or sulfoisophthalic acid. Additional examples of modifying diacarboxylic acids are fumaric; maleic; itaconic; 1,3-cyclohexanedicarboxylic; diglycolic; 2,5-norbornanedicarboxylic; phthalic; diphenic; 4,4′-oxydibenzoic; and 4,4′-sulfonyldibenzoic.

To obtain the desired flow characteristics within the mold, the polyesters of the present invention have an inherent viscosity of 0.4 to 1.5 dL/g, typically from 0.55 to 0.70 dL/g. The inherent viscosity, abbreviated herein as “I.V.”, refers to inherent viscosity determinations made at 25° C. using 0.25 gram of polymer per 50 mL of a solvent composed of 60 weight percent phenol and 40 weight percent 1,1,2,2-tetrachloroethane. Other examples of I.V. values which may be exhibited by the polyester compositions are 0.55 to 0.67 dL/g, 0.55 to 0.65 dL/g, and 0.60 to 0.65 dL/g.

The polyesters of the instant invention are readily prepared from the appropriate dicarboxylic acids, esters, anhydrides, or salts, the appropriate diol or diol mixtures, and optional branching monomers using typical polycondensation reaction conditions. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The term “continuous” as used herein means a process wherein reactants are introduced and products withdrawn simultaneously in an uninterrupted manner. By “continuous” it is meant that the process is substantially or completely continuous in operation in contrast to a “batch” process. “Continuous” is not meant in any way to prohibit normal interruptions in the continuity of the process due to, for example, start-up, reactor maintenance, or scheduled shut down periods. The term “batch” process as used herein means a process wherein all the reactants are added to the reactor and then processed according to a predetermined course of reaction during which no material is fed or removed into the reactor. The term “semicontinuous” means a process where some of the reactants are charged at the beginning of the process and the remaining reactants are fed continuously as the reaction progresses. Alternatively, a semicontinuous process may also include a process similar to a batch process in which all the reactants are added at the beginning of the process except that one or more of the products are removed continuously as the reaction progresses. The process is operated advantageously as a continuous process for economic reasons and to produce superior coloration of the polymer as the polyester may deteriorate in appearance if allowed to reside in a reactor at an elevated temperature for too long a duration.

The polyesters of the present invention are prepared by procedures known to persons skilled in the art. The reaction of the diol, dicarboxylic acid and, optionally, branching monomer components may be carried out using conventional polyester polymerization conditions. For example, when preparing the polyester by means of an ester interchange reaction, i.e., from the ester form of the dicarboxylic acid components, the reaction process may comprise two steps. In the first step, the diol component and the dicarboxylic acid component, such as, for example, dimethyl terephthalate, are reacted at elevated temperatures, typically, 150° C. to 250° C. for 0.5 to 8 hours at pressures ranging from 0.0 kPa gauge to 414 kPa gauge (60 pounds per square inch, “psig”). Preferably, the temperature for the ester interchange reaction ranges from 180° C. to 230° C. for 1 to 4 hours while the preferred pressure ranges from 103 kPa gauge (15 psig) to 276 kPa gauge (40 psig). Thereafter, the reaction product is heated under higher temperatures and under reduced pressure to form the polyester with the elimination of diol, which is readily volatilized under these conditions and removed from the system. This second step, or polycondensation step, is continued under higher vacuum and a temperature which generally ranges from 230° C. to 350° C., preferably 250° C. to 310° C. and, most preferably, 260° C. to 290° C. for 0.1 to 6 hours, or preferably, for 0.2 to 2 hours, until a polymer having the desired degree of polymerization, as determined by inherent viscosity, is obtained. The polycondensation step may be conducted under reduced pressure which ranges from 53 kPa (400 torr) to 0.013 kPa (0.1 torr). Stirring or appropriate conditions are used in both stages to ensure adequate heat transfer and surface renewal of the reaction mixture. The reaction rates of both stages are increased by appropriate catalysts such as, for example, alkoxy titanium compounds, alkali metal hydroxides and alcoholates, salts of organic carboxylic acids, alkyl tin compounds, metal oxides, and the like. A three-stage manufacturing procedure, similar to that described in U.S. Pat. No. 5,290,631, may also be used, particularly when a mixed monomer feed of acids and esters is employed.

To ensure that the reaction of the diol component and dicarboxylic acid component by an ester interchange reaction is driven to completion, it is sometimes desirable to employ 1.05 to 2.5 moles of diol component to one mole dicarboxylic acid component. Persons of skill in the art will understand, however, that the ratio of diol component to dicarboxylic acid component is generally determined by the design of the reactor in which the reaction process occurs.

In the preparation of polyester by direct esterification, i.e., from the acid form of the dicarboxylic acid component, polyesters are produced by reacting the dicarboxylic acid or a mixture of dicarboxylic acids with the diol component or a mixture of diol components and the branching monomer component. The reaction is conducted at a pressure of from 7 kPa gauge (1 psig) to 1379 kPa gauge (200 psig), preferably less than 689 kPa (100 psig) to produce a low molecular weight polyester product having an average degree of polymerization of from 1.4 to 10. The temperatures employed during the direct esterification reaction typically range from 180° C. to 280° C., more preferably ranging from 220° C. to 270° C. This low molecular weight polymer may then be polymerized by a polycondensation reaction.

The polyester may further comprise one or more additives to improve processing, appearance, strength, and other physical properties as desired. Examples of additives include antioxidants, melt strength enhancers, chain extenders, flame retardants, fillers, dyes, colorants, pigments, chopped fibers, glass, impact modifiers, carbon black, talc, TiO₂, nanoclays, flow enhancers, processing aids, mold release additives, plasticizers, and the like as desired. Colorants, sometimes referred to as toners, may be added to impart a desired neutral hue and/or brightness to the polyester and the resulting hollow article prepared therefrom.

Branching monomers may be added to the polyester to improve processing of large parts. For example, the polyester may comprise 0.05 to 1 weight percent (wt %), based on the total weight of the polyester, of one or more residues of a branching monomer having 3 or more carboxyl substituents, hydroxyl substituents, or a combination thereof. Examples of branching monomers include, but are not limited to, multifunctional acids or glycols such as trimellitic acid, trimellitic anhydride, pyromellitic dianhydride, trimethylolpropane, glycerol, pentaerythritol, citric acid, tartaric acid, 3-hydroxyglutaric acid and the like. Preferably, the branching monomer residues comprise 0.1 to 0.7 mole percent of one or more residues of: trimellitic anhydride, pyromellitic dianhydride, glycerol, sorbitol, 1,2,6-hexanetriol, pentaerythritol, trimethylolethane, or trimesic acid. The branching monomer may be added to the polyester reaction mixture or blended with the polyester in the form of a concentrate as described, for example, in U.S. Pat. No. 5,654,347.

The polyesters of the instant invention also may comprise 0.05 weight percent to 2 weight percent, based on the total weight of said polyester, of one or more chain extenders to increase viscosity and improve the impact properties of the molded article. Typically, chain extenders comprise multifunctional compounds such as, for example, carbonyl bis(caprolactam), bis(oxazoline) (e.g., 1,4-phenylene-bis-oxazoline), diepoxides (e.g. ARALDITE® MY 721), and carboxylic diacid anhydrides. The chain extenders may be added to the polyester during the polymerization step or melt blended the final polyester after polymerization. Further exemplary chain extenders are divinyl ethers such as, for example, those disclosed in U.S. Pat. No. 5,817,721 or diisocyanates such as, for example, those disclosed in U.S. Pat. No. 6,303,677. Representative divinyl ethers are 1,4-butanediol divinyl ether, 1,5-hexanediol divinyl ether, and 1,4-cyclohexandimethanol divinyl ether. It is also possible to use agents such as sulfoisophthalic acid to increase the melt strength of the polyester to a desirable level.

The polyesters of our invention also may comprise one or more mold release additives to prevent sticking of the polyester to the mold. The mold release additive typically comprises 0.05 wt % to 5 wt %, based on the total weight of said polyester of one or more fatty acid amides, such as erucylamide and stearamide; metal salts of organic acids, such as calcium stearate and zinc stearate; fatty acids, such as stearic acid, oleic acid, and palmitic acid; fatty acid salts; fatty acid esters; hydrocarbon waxes, such as paraffin wax; ester waxes, such as carnauba wax; phosphoric acid esters, chemically modified polyolefin waxes; polyethylene waxes; polypropylene waxes; fluoropolymers; glycerin esters, such as glycerol mono- and distearates; talc; microcrystalline silica; and acrylic copolymers (for example, PARALOID® K175 available from Rohm & Haas). The optimum amount of additive used is determined by factors well known in the art and is dependent upon variations in equipment, material, process conditions, and the wall thickness of the hollow article. Additional examples of additive levels are 0.1 to 5 wt % and 0.1 to 2 wt %. Typically, the additive comprises one or more of: erucylamide, stearamide, calcium stearate, zinc stearate, stearic acid, montanic acid, montanic acid esters, montanic acid salts, oleic acid, palmitic acid, paraffin wax, polyethylene waxes, polypropylene waxes, carnauba wax, glycerol monostearate, or glycerol distearate.

Antioxidants also may be used with polyesters of the present invention to prevent oxidative degradation during processing of the molten or semi-molten material on the rolls. Such antioxidants typically comprise one or more phenols, phosphites, phosphonites, or sulfides. Additional examples of antioxidants include esters such as distearyl thiodipropionate or dilauryl thiodipropionate; phenolic stabilizers such as IRGANOX® 1010, available from Ciba-Geigy Specialty Chemicals, ETHANOX® 330, available from Ethyl Corporation, and butylated hydroxytoluene; and phosphorus containing stabilizers such as IRGAFOS®, available from Ciba-Geigy Specialty Chemicals, and WESTON® stabilizers, available from GE Specialty Chemicals. These antioxidants may be used alone or in combinations.

The various additives such as, for example, the mold release agent, antioxidant, or chain extender, may be blended in batch, semicontinuous, or continuous processes. Small scale batches may be readily prepared in any high-intensity mixing devices well-known to those skilled in the art, such as Banbury mixers, prior to introduction into the mold. The components also may be blended in solution in an appropriate solvent. The melt blending method includes blending the polyester and any additional non-polymerized components at a temperature sufficient to melt the polyester. The blend may introduced directly into the mold or, preferably, is cooled, pelletized, and/or ground prior to introduction into the mold. The term “melt” as used herein includes, but is not limited to, merely softening the polyester. When colored articles are desired, pigments or colorants may be included in the polyester mixture during the reaction of the diol and the dicarboxylic acid or they may be melt blended with the preformed polyester. A preferred method of including colorants is to use a colorant having thermally stable organic colored compounds having reactive groups such that the colorant is copolymerized and incorporated into the polyester to improve its hue. For example, colorants such as dyes possessing reactive hydroxyl and/or carboxyl groups, including, but not limited to, blue and red substituted anthraquinones, may be copolymerized into the polymer chain. When dyes are employed as colorants, they may be added to the polyester reaction process after an ester interchange or direct esterification reaction.

The polyester of the invention has an inherent viscosity of 0.4 to 1.5 dL/g, preferably from 0.55 to 0.70 dL/g to obtain the optimal flow characteristics within the mold. As described hereinabove, the polyester may be in liquid or solid form, but preferably the polyester is introduced into the mold in a form which permits the polyester to evenly contact the walls of the mold such as, for example, as particles in the form of a powder, granules, microspheres, or pellets having an particle size distribution in which at least 99% of the particles by weight are 1000 microns (μ) or less in diameter as measured by ASTM Method D1921. In one example, at least 70 weight percent of the polyester particles have a particle diameter of 500μ or less. In another example; at least 80 weight percent of the polyester particles have a particle diameter of 500μ or less. For example, the polyester particles may be in the form of micropellets in which at least 80 weight percent of the particles have a particle diameter of 500μ or less may be used. Such micropellets may be produced using the granulation process developed by Gala Industries.

The polyesters of our novel process can be processed in most commercial rotational molding machines. Our rotational molding process comprises introducing the thermoplastic polyester into a mold and rotating the mold at a peak internal air temperature of 150° C. to 320° C. As noted above, the polyester is typically introduced into the mold as a liquid, powder, granules, microspheres, or pellets which are moved throughout the mold and contact the interior surfaces. The polyester may be predried or excess moisture vented as needed during the rotational molding process to prevent polymer degradation and/or bubble formation. The term “peak internal air temperature”, as used herein, is the highest temperature within the internal airspace of the mold measured during the molding process. The peak internal air temperature does not necessary equal and may be less than the temperature of the molten polyester or the skin temperature of the mold. The mold temperature must be sufficient to melt the polyester and will depend on various factors including the size of the mold, mold geometry, thickness of the part being rotomolded, and the polyester composition. Further examples of peak internal air temperatures within the mold during the heating step and rotation steps are from 150° C. to 300° C., 150° C. to 255° C., and from 150° C. to 240° C. If the temperature is too high during rotational molding, the color, clarity, strength, and other physical properties of the polyester article may deteriorate. The temperature must be high enough for the polyester particles to fuse together to form a smooth inner surface of the molded article.

The mold is heated by suitable means known in the art such as, for example, forced air, gas flame, oil, infrared radiators, electrical or induction heating. Typically, however, heating is accomplished by placing the mold in a forced air circulating oven. While heating, the mold is rotated uniaxially or biaxially at a speed which permits the polyester to contact the inner walls of the mold by action of gravity, thereby forming a molten polyester layer within the mold. The mold is then cooled to solidify the polyester and to permit removal of the molded product. Because the rotational molding method is based on the principle that a molten polymer flows with rotation of a mold to form a molten polymer layer on the mold surface, it is advantageous for the polyester to have good fluidity and melt-flow characteristics to obtain a molded product having a good appearance or the molded product may contain air bubbles or have an uneven inner surface.

The length of time required to rotomold the article will depend on the fluidity and melt flow properties of the polyester and the temperature. As a result, time and temperature will vary within wide limits. Optionally, the interior surfaces of the mold may be treated with a suitable mold release additive prior to the introduction of the polyester into the mold. The mold release additive may be in addition to any mold release additive that may be present in the polyester. To further enhance the release of the article from the mold, a mold with a polished surface or a surface coated with a fluoropolymer (e.g., a polyfluorinated olefin such as polytetrafluoroethylene or “TEFLON®”) may be used.

For achieving special designs and appearance, technologies such as Mold-In Graphics Systems® which uses Spray-In Color Systems® or in mold labeling film may be used. Mold design may follow principles developed for polyolefin molds; however the lower shrinkage of polyester has to be taken into account. For the polyesters of our invention, it is generally advantageous to use a good mold release system (i.e., additives in combination with mold surface structure and treatment) and wide demolding angles.

For the molding process, the mold may be rotated uniaxially or biaxially, i.e., in one or two directions, utilizing conventional rotational molding equipment. The speed of rotation of the mold in the two directions can also be varied between wide limits. Generally, the rate of rotation will be between 1 and 25 rpm. The rate of rotation of the mold each axis is limited by machine capability and the shape of the article being molded. The range of rotation ratio (major:minor axis) which may be used with the present invention from 1:2 to 1:10 and 2:1 to 10:1. Typically the rotation ratio is 4:1.

The mold may be maintained under pressure or vacuum during processing as need to help remove voids and bubbles which may result from the presence of dissolved air, polymer volatiles, or moisture in the polymer. For example, our rotational molding process may be conducted under pressure to help prevent the formation of bubbles in the molded article. Typically, mold is maintained at a gauge pressure of 50 to 700 kilopascals (kPa) during all or a portion of the rotational molding process. Other examples of pressures which may be used are 50 to 500 kPa and 50 to 300 kPa. In the event that the polyester is sensitive to oxygen, the process of our invention a may be conducted in the presence of an inert gas such as, for example, nitrogen, helium, argon, carbon dioxide, or mixtures of one or more of these gases with each other or with air. The term “inert gas”, as used herein, is intended to mean a gas or mixture of gases which do not result in oxidation of the polyester or which are otherwise unreactive with the polyester under rotational molding conditions of time, temperature, and pressure. For example, the mold cavity can be purged with nitrogen. Alternatively, dry ice can be added to the mold cavity at the time the resin is charged to the mold. The dry ice will sublime during the heating cycle and provide an inert atmosphere.

After the heating and rotation step, the mold is cooled to allow the molded article to be easily removed from the mold and retain its shape. The mold may be cooled by any conventional means, such as, with a chilled (i.e., at temperature below ambient temperature) gas, for example, air, nitrogen, or carbon dioxide. Alternatively, the mold may be cooled by using a water spray. The water is typically at cold water tap temperature, i.e., from 4° C. to 16° C. After the water cooling step, another air cooling step optionally may be used. This is usually a short step during which the equipment dries with heat removed during the evaporation of the water.

In another embodiment of our inventive process, the polyester comprises particles in the form of a powder, granule, microspheres, or pellets and has a particle size distribution wherein at least 70 weight percent of the particles are 500 microns (μ) or less in diameter as measured by ASTM Method D1921; the polyester has a crystallization half time from a molten state of at least 15 minutes, an inherent viscosity of 0.55 to 0.70 dL/g, and comprises:
(a) diacid residues comprising at least 90 mole percent, based on the total moles of diacid residues, of one or more residues of: terephthalic acid, naphthalene-dicarboxylic acid, 1,4-cyclohexanedicarboxylic acid, or isophthalic acid; and
(b) diol residues comprising 20 to 70 mole percent, based on the total moles of diol residues, of one or more residues of: 1,4-cyclohexanedimethanol, neopentyl glycol, or diethylene glycol; and 30 to 80 mole percent of the residues of one or more diols selected from ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol.
   As described hereinabove, the mold may be rotated at a peak internal air temperature of 150 to 255° C. The polyester has a crystallization half time from a molten state of at least 15 minutes. Other examples of crystallization half time that may be exhibited by the polyester are at least 20 minutes, at least 25 minutes, at least 30 minutes, and at least 60 minutes. The polyester is introduced into the mold in the form of a powder, granule, microsphere, or pellet and has a particle size distribution wherein at least 70 weight percent of the particles are 500 microns (μ) or less. The diacid residues of the polyester comprise at least 90 mole percent (mole %), based on the total moles of diacid residues, of one or more residues of terephthalic acid, naphthalenedicarboxylic acid, 1,4-cyclohexane-dicarboxylic acid, or isophthalic acid. Any of the various isomers of naphthalene-dicarboxylic acid or mixtures of isomers may be used, but the 1,4-, 1,5-, 2,6-, and 2,7-isomers are preferred. Cycloaliphatic dicarboxylic acids such as, for example, 1,4-cyclohexanedicarboxylic acid may be present at the pure cis or trans isomer or as a mixture of cis and trans isomers.

The polyester also may comprise 20 to 70 mole %, based on the total moles of diol residues, of the residues of 1,4-cyclohexanedimethanol, neopentyl glycol, or diethylene glycol; and 30 to 80 mole percent of the residues of one or more diols selected from ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol. Further examples of diols that may be used in the polyesters of our invention are triethylene glycol; polyethylene glycols; 2,4-dimethyl-2-ethylhexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,5-pentanediol; thiodiethanol; 1,2-cyclohexanedimethanol; 1,3-cyclohexanedimethanol; p-xylylenediol; bisphenol S; or combinations of one or more of these glycols. As described previously, the cycloaliphatic diols, for example, 1,3- and 1,4-cyclohexanedimethanol, may be present as their pure cis or trans isomers or as a mixture of cis and trans isomers.

The polyester also may further comprise from 0 to 10 mole percent of the residues of one or more modifying diacids containing 4 to 40 carbon atoms as described previously. Examples of modifying dicarboxylic acids that may be used include aliphatic dicarboxylic acids, alicyclic dicarboxylic acids, aromatic dicarboxylic acids, or mixtures of two or more of these acids. Specific examples of modifying dicarboxylic acids include, but are not limited to, one or more of succinic acid, glutaric acid, adipic acid, suberic acid, sebacic acid, azelaic acid, dimer acid, or sulfoisophthalic acid. Additional examples of modifying diacarboxylic acids are fumaric; maleic; itaconic; 1,3-cyclohexane-dicarboxylic; diglycolic; 2,5-norbornanedicarboxylic; phthalic; diphenic; 4,4′-oxydibenzoic; and 4,4′-sulfonyldibenzoic.

The polyester also may comprise the various additives such as, for example, chain extenders, branching monomers, antioxidants, and mold release additives as described previously. In addition, the process may further comprise the various embodiments of the rotational molding processes described hereinabove, including temperatures, pressures, mold characteristics, and the use of mold release agents. For example, in one embodiment of our inventive process, the crystallization half time of the polyester is at least 20 minutes and the mold is maintained at an absolute pressure of 50 to 700 kilopascals (kPa) during all or a portion of the rotation step (step (b)) of our process as described hereinabove.

Multilayered or multiwalled rotational molded articles may be produced by our process to achieve certain desired properties as enhanced barrier or optimized mechanical performance. Typically, two to three layers are formed during the process by adding the different materials into the mold at a defined time. Thus, our inventive process may further comprise introducing an additional thermoplastic polymer into the mold and rotating the mold at a peak internal air temperature greater than the melting point of the thermoplastic polymer before the introduction of the thermoplastic polyester (step (a)) or after rotation of the polyester in the heated mold (step (b)). Any thermoplastic polymer that melts at the peak internal air temperature or below may be used. Examples of additional thermoplastic polymers are one or more polymers selected from polyolefins, polyesters, polycarbonates, polyvinyl chlorides, and polyamides.

Alternatively, layered articles also may be made in several molding cycles, although this method is generally less economical. These layers may be compatible and form adhesive bonds, molded as loose layers, or may use a tie layer to guarantee proper adhesion. It is also possible to blend polyesters, by dry blending or compounding, with certain other polymers, to form compatible or noncompatible blends in order to reach desired mechanical or physical properties or to create special design or visual effects. These blends may be done prior to molding by use of dry blending systems or compounding equipment but also can be done directly in the mold. Compatible polymers are other polyesters such as polyether block-esters, other copolyesters as described above, polyolefin copolymers such as, for example, ethylene methyl acrylate, ethylene acrylic acid, ethylene butyl acetate, and ethylene vinyl acetate.

The process of the invention is particularly useful for the manufacture of hollow articles. Our invention thus provides a hollow article, comprising:
(a) a thermoplastic polyester having a crystallization half time from a molten state of at least 15 minutes and an inherent viscosity of 0.55 to 0.70 dL/g, wherein said crystallization half time is measured from the molten state using a differential scanning calorimeter (DSC) by heating a 15.0 mg sample of the polyester in an aluminum pan to 290° C. at a rate of 320° C. per minute for 2 minutes, cooling the sample to the isothermal crystallization temperature at a rate of 320° C. per minute in the presence of helium and determining the time span from reaching the isothermal crystallization temperature to the point of a crystallization peak on the DSC curve, and wherein the polyester is a random copolymer comprising
   (i) diacid residues comprising at least 90 mole percent, based on the total moles of diacid residues, of one or more residues of: terephthalic acid, naphthalenedicarboxylic acid, 1,4-cyclohexanedicarboxylic acid, or isophthalic acid; and
   (ii) diol residues comprising 10 to 100 mole percent, based on the total moles of diol residues, of one or more residues of: 1,4-cyclohexanedimethanol, neopentyl glycol, or diethylene glycol; and 0 to 90 mole percent of one or more residues of diols selected from ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol;

wherein the hollow article is prepared by a rotational molding process.

The hollow article may encompass the various embodiments, concentration ranges, combinations, and process parameters as described hereinabove for the polyester including, but not limited to, the physical form of the polyester, particle diameters, diacid and diol components, modifying diacids, branching monomers, and additives, and the various embodiments described hereinabove for the rotational molding processes. The invention is illustrated further by the following examples.

### EXAMPLES

### Examples 1-6

Rotational molding experiments were conducted using a copolyester containing 100 mole % terephthalic acid, 69 mole % ethylene glycol, and 31 mole % 1,4-cyclohexanedimethanol (CHDM) (Eastar® 5011, available from Eastman Chemical Co.) and having an inherent viscosity of 0.60 dL/g as determined at 25° C. using 0.25 gram of polymer per 50 mL of a solvent composed of 60 weight percent phenol and 40 weight percent 1,1,2,2-tetrachloroethane. The crystallization ½ time of the polyester was >15 minutes and was determined using a differential scanning calorimeter (DSC) by heating a 15.0 mg sample of the polyester in an aluminum pan to 290° C. at a rate of about 320° C. per minute for 2 minutes, cooling said sample to the isothermal crystallization temperature at a rate of about 320° C. per minute in the presence of helium and determining the time span from reaching the isothermal crystallization temperature to the point of a crystallization peak on the DSC curve. The polyester was cryogenically ground to a powder. The flow properties of the powder and measurements of bulk density were measured in accordance with ASTM D1895-89. The results of these measurements are shown Table 1 below.

TABLE 1
Flow and Bulk Density of Copolyester Used in Experiments 1-6

| Property | Value |
|---|---|
| Dry Flow | 12.02 sec/100 g |
| Bulk Density | 605 Kg/m³ |

Sieve analysis, using ATSM Method D1921, was used to measure the particle size distribution of the copolyester powder and the results are shown Table 2. About 84% of the copolyester powder was less than 500 microns (μm) and about 24% of the powder was less than 150 μm in diameter.

TABLE 2
Particle Size Distribution of the Copolyester Powder

| Mesh Aperture | % Mass Powder |
|---|---|
| 0 | 6.3 |
| 90 | 1.8 |
| 106 | 16.26 |
| 180 | 6.1 |
| 212 | 14.94 |
| 300 | 19.88 |
| 425 | 10.18 |
| 500 | 9 |
| 600 | 11.68 |
| 850 | 3.34 |

In each of Examples 1-6, a hollow plastic cube was produced using a ROTOSPEED® rotational molding machine having an aluminium cube mold with a central vent port. The shot weight was set at 1.8 kg. The mold was removed from the oven at various internal air and oven temperatures, cooled, and the rotomolded cube removed from the mold. Examples 4-6 were conducted using pressure. The ROTOLOG® temperature measurement system was used to record the temperature profiles of the internal air, material, and mold, as well as that of the oven. The system consists of an insulated radio transmitter, which is attached to the mold and travels with it in the oven and the cooler bay. The transmitter sends a signal to a receiver, which in turn is connected to a computer that uses the ROTOLOG® software to graph real-time temperature/time data.

The following conditions were used in Examples 1-6:

Oven temperature: 280° C., 300° C. and 320° C.

Rotation ratio: 4:1

Cooling medium: Forced air

Preheated arm & mold

ROTOLOG® unit No. 5/ROTOLOG® software version 2.7

The total cycle times for the examples are shown below in Table 3. All cycle times are taken from the same start point of 55° C. to allow for easier comparisons of the various stages of an internal air temperature trace. The cycle times for the non-pressurised trials are shown below in Table. Example 1 showed a large number of bubbles present in the material when the material was removed at a peak internal air temperature (abbreviated as “PIAT” in the Tables) of 249° C. In an effort to remove the bubbles, a higher PIAT was used; this higher temperature had the effect of causing the material to “yellow” slightly thus indicating that degradation may have occurred. The bubbles were still present in Example 2. Example 3 was conducted using a lower oven temperature than the previous trials and a lower PIAT; bubbles, however, were still present.

TABLE 3
Rotational Molding Conditions

| | Oven Temp | PIAT | | Cycle Time |
|---|---|---|---|---|
| Example | (° C.) | (° C.) | Pressure | (mins) |
| 1 | 320 | 249 | NONE | 27.35 |
| 2 | 320 | 273 | NONE | 31.71 |
| 3 | 280 | 243 | NONE | 31.85 |
| 4 | 300 | 247 | 69 kPa at 127° C. | 26.75 |
| 5 | 280 | 249 | 69 kPa at 249° C. | 32.45 |
| 6 | 280 | 243 | 69 kPa at 192° C. | 28.54 |

The cycle times for the pressurised trials are shown in Table 3. Examples 4 to 6 were conducted using 69 kPa (gauge) of pressure applied at different times in the cycle. Example 4 was conducted with an oven temperature of 300° C. The pressure was applied approximately 5 minutes into the cycle and this pressure was maintained for the duration of the experiment. When the part was removed, there appeared to be less bubbles present than was observed the trials carried out without pressure. In Example 5, the molding was conducted with a lower oven temperature and the pressure was applied 15 minutes into the cycle, just as the PIAT was achieved. The number of bubbles remaining at the end of the trial, however, was unaffected. Example 6 was conducted at an oven temperature of 280° C., while the pressure was applied 7 minutes into the cycle. Once again the effect on the number of bubbles was negligible.

The surfaces of all the molded cubes appeared ‘uneven’, it is thought that this is reflected by the porous nature of the aluminum cube mold. However it was also observed that the polished inserts on the lid of each mold produced a clear almost “see through” finish on the corresponding molding surface. This surface had fewer bubbles than the surrounding unpolished aluminium surface.

### Examples 7-8

Hollow, cylindrical articles were prepared on a uniaxial rotational molding machine using a copolyester containing 100 mole % terephthalic acid, 69 mole % ethylene glycol, and 31 mole % 1,4-cyclohexanedimethanol (CHDM) (Eastar® 5011, available from Eastman Chemical Co.) and having an inherent viscosity of 0.60 dL/g as determined at 25° C. using 0.25 gram of polymer per 50 mL of a solvent composed of 60 weight percent phenol and 40 weight percent 1,1,2,2-tetrachloroethane. The polyester exhibited a crystallization ½ time of >15 minutes as determined by the DSC procedure described in Examples 1-6. The polyester was cryogenically ground to a powder. The flow properties and bulk density of the powder were determined in accordance with ASTM D1895-89. The results of these measurements are shown Table 4 below.

TABLE 4
Flow and Bulk Density of Copolyester Used in Experiments 7-9

| Property | Value |
|---|---|
| Dry Flow | 18.02 sec/100 g |
| Bulk Density | 468 Kg/m³ |

Sieve analysis (ASTM Method D1921) was used to measure the particle size distribution of the copolyester powder and the results are shown Table 5. About 97% of the copolyester powder was 300 μm or less and about 27% of the powder was less than 212 μm in diameter.

TABLE 5
Particle Size Distribution of the Copolyester Powder for Examples 7-8

| Mesh Aperture | % Mass Powder |
|---|---|
| 0 | 0.83 |
| 90 | 1.00 |
| 106 | 25.50 |
| 212 | 31.40 |
| 300 | 38.47 |
| 425 | 1.70 |
| 500 | 0.40 |
| 600 | 0.27 |
| 850 | 0.17 |

### Example 7

A shot weight of 200 g was used with a rotation speed of 12 rpm. The mold was preheated to 70° C., the powder was then added. It was noted that at a internal air temperature of 47° C., after only 1 minute into the cycle, the polyester had started to adhere to the mold surface. Two patches developed in the mold; these patches corresponded to the hottest areas of the mold, directly in line with the heater bands. After 3 minutes, the mold temperature was increased to 80° C. and after 6 minutes the mold temperature was increased to 90° C.

After 9.7 minutes, all of the powder had adhered to the mold and the mold temperature was increased to 300° C. After 16 minutes, the powder exposed to the air was starting to melt and go clear, it was at this time that the mold temperature was raised again to 340° C. to try and remove the bubbles. Cooling was initiated after 36 minutes, at an internal air temperature of 278° C. A clear cylindrical article was obtained from the mold. The article, however, was incomplete because of insufficient shot weight.

### Example 8

In this example, the shot weight of powder used was increased to 442 g. The rotation speed was increased to 15 rpm. The powder was placed into a mold at 26° C. and the mold temperature was then set to 50° C. The temperature of the powder particles was increased slowly as shown in the Table 6 below.

TABLE 6
Temperature Profile for Example 8

| Time (Minutes) | Temperature Set Point (° C.) |
|---|---|
| 0 | 50 |
| 3.01 | 60 |
| 6.43 | 70 |
| 8.76 | 80 |
| 12.51 | 90 |
| 14.51 | 100 |
| 15.80 | 110 |
| 17.82 | 120 |
| 18.485 | 300 |
| 33 | Cool Down |

At 14.35 minutes all of the mold had been covered and by 17.82 minutes all of the powder pool had been used up. The molding was conducted at a PIAT of 238° C. A clear, cylindrical object containing few bubbles was obtained from mold after cooling with forced air.

### Examples 9-15

Hollow cube shaped articles were prepared by biaxial rotational molding using the copolyester described in Examples 7-8. The moldings were carried out using the CACCIA 1400R rotational molding machine. This machine was used to achieve the lower oven temperatures required to gradually heat the powder in the mold.

### Example 9

In this example the following parameters were used:

Shot weight 1.8 kg

Mold not preheated

Initial oven set point 80° C.

Rotational ratio 4:1

No pressure applied

The lower oven temperature were maintained by manually switching the oven on and off. The oven set points are shown in Table 7 below. A hollow polyester cube was obtained.

TABLE 7
Temperature Profile for Example 9

| Time (Minutes) | Temperature Set Point (° C.) |
|---|---|
| 0 | 80 |
| 15.33 | 90 |
| 25.33 | 100 |
| 34.33 | 150 |
| 39 | 250 |
| 43 | 300 |
| 60 | 340 |

### Example 10

In this example the following parameters were used:

Shot weight 2.5 kg

Preheated mold

Initial oven set point 110° C.

Rotational ratio 1:4

No pressure applied

A bigger shot weight was used and the rotation ratio reversed from 4:1 to 1:4 in an attempt to try and get the material to adhere to the sides of the molding. The oven set points are shown below in Table 8.

TABLE 8
Temperature Profile for Example 10

| Time (Minutes) | Temperature Set Point (° C.) |
|---|---|
| 0 | 110 |
| 20 | 120 |
| 31 | 140 |
| 41 | 200 |
| 51 | 330 |
| 71 | Removed from Oven |

The mold was removed from the oven at a PIAT of 243° C. The complete cycle took 104 minutes and the final part is shown in FIG. 4.2 above. Because of the increased shot weight, there was a greater coating of the copolyester on the molding. Also, bubbles similar in size and density to Example 1 were observed.

### Example 11

In this example the following parameters were used:

Shot weight 3.0 kg

Preheated mold

Initial oven set point 80° C.

Rotational ratio 1:4

70 kPa (gauge) of pressure applied at 104° C., 40 minutes into cycle

The oven set points are shown below in Table 9.

TABLE 9
Temperature Profile for Example 11

| Time (Minutes) | Temperature Set Point (° C.) |
|---|---|
| 0 | 80 |
| 17.25 | 120 |
| 27.25 | 340 |

The molding cycle took a total time of 80 minutes to complete and reached a PIAT of 243° C. The hollow cube showed a decrease in the amount of bubbles present in comparison with examples 9 and 10. This decrease in bubble density and size is the result of the use of pressure.

### Example 12

In this example the following parameters were used:

Shot weight of 3.0 kg

Preheated mold

Initial oven set point 80° C.

Rotation ratio 1:4

138 kPa (gauge) of pressure applied at 105° C.

The pressure in the mold was doubled from 69 kPa to 138 kPa (gauge) and the inside of the mold was rubbed with wire wool to improve the adhesion between the polymer and the mold wall. The oven set points are shown below in Table 10.

TABLE 10
Temperature Profile for Example 12

| Time (Minutes) | Temperature Set Point (° C.) |
|---|---|
| 0 | 135 |
| 12 | 200 |
| 27 | 340 |

The molding cycle took a total time of 70 minutes to complete and reached a PIAT of 253° C. The hollow cube that was obtained. No effect of rubbing wire wool on the inside of the molding was observed.

### Example 13

In this trial the following parameters were used:

Shot weight of 3.0 kg

Cold mold

Initial oven set point 135° C.

Rotation Ratio 1:4

138 kPa (gauge) of pressure applied at 105° C.

In this example, delayed cooling was employed. Once the mold was removed from the oven, the cooling fan was not switched on until the temperature of the internal air had dropped to 208° C. This procedure was carried out to give the copolyester more time in the molten state to reduce the bubble size. The oven set points are shown below in Table 11.

TABLE 11
Temperature Profile for Example 13

| Time | Temperature Set Point |
|---|---|
| (Minutes) | (° C.) |
| 0 | 135 |
| 14 | 200 |
| 27 | 340 |

The molding cycle took a total time of 94 minutes to complete and reached a PIAT of 263° C. There was a definite yellowing of the final part; this may be explained by the higher PIAT that the copolyester experienced and that the copolyester remained in the molten state for a longer period of time because to the delayed cooling. A decrease in the amount of bubbles present was observed in comparison to the previous examples.

### Example 14

In this example the following parameters were used:

Shot weight of 3.0 kg

Preheated mold

Initial oven set point 150° C.

Rotation ratio 1:4

138 kPa (gauge) of pressure applied at 105° C.

In this example, the effect of oversize particles on bubble removal was observed. Of the 3 kg of copolyester powder used, 486.4 g (16%) of the powder were composed of particles have a diameter greater than 500 microns and 2513.6 g (84%) of the powder were composed of particles between 425 and 500 microns. Delayed cooling was also used. The oven set points are shown below in Table 12.

TABLE 12
Temperature Profile for Example 14

| Time | Temperature Set |
|---|---|
| (Minutes) | Point (° C.) |
| 0 | 150 |
| 2 | 192 |
| 10 | 340 |

The molding was carried out to a PIAT of 251° C. The molding cycle lasted 58 minutes. Additionally, there was an increase in the bubble density.

### Comparative Examples 1-3

Commercially available polyesters (PETG, PCTG, and PET, available from Eastman Chemical Company) having an inherent viscosity between 0.73 and 0.80 dL/g were rotationally molded on standard rotational molding machines (an Alan Yorke 3 arm carousel machine and a Caccia Rotobox®). The polyesters were cryogenically ground to a powder having a particle size of less than 1000 microns. The crystallization ½ times for the PETG and PCTG samples was >15 minutes and 2.2 minutes for the PET sample as determined by the DSC procedure described in Examples 1-6. Oven set points were between 300° C. and 320° C. and cycle times were between 25 and 35 minutes. All of the polyesters failed to form shaped articles and, instead, formed lumps. Increasing oven temperature possibly would improve the polyester flow characteristics, but higher temperatures would increase degradation of the polymer. In the case of PET, the crystalline nature of the polyester resulted in the formation a powder lumps which stuck together and no sign of wall formation was evident.

### Comparative Example 4

A cryogenically ground, commercially available polyester (PETG 5826, available from Eastman Chemical Company) having an inherent viscosity of 0.44 was rotationally molded on a single arm FSP Rotoflow M-120 molding machine. A 2 kg shot weight was used. The particle size distribution of the powder was ranged from 10-500 microns. The crystallization ½ time for the PETG sample was >15 minutes as determined by the DSC procedure described in Examples 1-6. The oven set point was 280° C. and the cycle time was 15 minutes. The molded article was well-fused but brittle as a result of the low inherent viscosity of the polyester.

### Examples 16-30

Polyester samples (20 grams) were cryogenically ground to give a powder having a particle size of 1000 microns or less. The samples were placed in a laboratory hot air oven and the fusion characteristics determined at 10 and/or 15 minutes as shown in Table 13.

TABLE 13
Fusion Characteristics of Various Polyesters

| | | Cryst ½ | I.V. | Oven Set | 10 min | 15 min |
|---|---|---|---|---|---|---|
| Example | Polyester | Time | dL/g | Temp (° C.) | Observation | Observation |
| 16 | PETG | >15 | 0.75 | 220 | | not fully fused |
| 17 | PETG | >15 | 0.74 | 220 | not fully | not fully fused |
| | | | | | fused | |
| 18 | PETG | >15 | | 220 | | not fully fused |
| 19 | PETG | >15 | 0.60 | 220 | fully fused | fully fused |
| 20 | PETG | >15 | 0.55 | 220 | fully fused | fully fused |
| 21 | PETG | >15 | 0.54 | 220 | fully fused | fully fused |
| 22 | PETG | >15 | 0.39 | 220 | fully fused | brittle |
| 23 | PCTG | >15 | 0.73 | 220 | | not fully fused |
| 24 | PCTA | 10 | 0.70 | 220 | | crystallized |
| 25 | PCTA | 8 | 0.62 | 220 | | crystallized |
| 26 | PETG | >15 | .74 | 270 | fully fused | fully fused, yellow |
| | | | | | | color (after 20 min) |
| 27 | PETG | >15 | .55 | 270 | fully fused | fully fused, yellow |
| | | | | | | color (after 20 min) |
| 28 | PET | 2.2 | .80 | 270 | crystalline | molten, crystallizes |
| | | | | | | on cooling, |
| | | | | | | yellow color (after |
| | | | | | | 20 min) |
| 29 | PET | 1.5 | .80 | 270 | crystalline | molten, crystallizes |
| | | | | | | on cooling, |
| | | | | | | yellow color (after |
| | | | | | | 20 min) |
| 30 | PET | 1 | .80 | 270 | crystalline | molten, crystallizes |
| | | | | | | on cooling, |
| | | | | | | yellow color (after |
| | | | | | | 20 min) |

### Example 31

A 20 g sample of PETG (PETG Copolyester 7870 available from Eastman Chemical Company) having an inherent viscosity of 0.56 dL/g and a moisture content of 221.3 ug/g (0.002%) was ground to a powder having a particle size of 500 micron or less. The polyester was heated in an open pan in a hot air oven at 220° C. The degradation of the polyester over time as qualitatively indicated by color and the decrease in inherent viscosity is shown in Table 14.

TABLE 14
Degradation of PETG at 220° C.

| Time (min) | Fusion Behavior/Color | I.V. (dL/g) |
|---|---|---|
| Pellets | powder white | 0.56 |
| 5 min | fusion almost completed, wavy surface | 0.58 |
| 12 min | fusion completed, surface almost flat | 0.55 |
| 20 min | absolute flat surface, colorless | 0.55 |
| 30 min | becomes yellowish | 0.54 |
| 45 min | increasingly yellowish | 0.54 |
| 75 min | yellowish | 0.54 |
| 120 min | yellow | 0.55 |
| 180 min | brownish, degrades (see I.V.) | 0.51 |

### Comparative Examples 5 and 6

Rotational molding experiments were conducted on 2 copolyester samples containing 100 mole % terephthalic acid, 62 mole % CHDM, and 38 mole % ethylene glycol. Sample 1 had an inherent viscosity of 0.75 dL/g and sample 2 had an inherent viscosity of 0.62 dL/g as determined at 25° C. using 0.25 gram of polymer per 50 mL of a solvent composed of 60 weight percent phenol and 40 weight percent 1,1,2,2-tetrachloroethane. The crystallization ½ time of the polyester samples was >15 minutes and was determined using a differential scanning calorimeter (DSC) as described previously. For each sample, the polyester was cryogenically ground to a powder.

Sieve analysis, using ATSM Method D1921, was used to measure the particle size distribution of the copolyester powder and the results are shown Table 15.

TABLE 15
Particle Size Distribution of the Copolyester Powder
Comparative Examples 5 and 6

| | Sample 1 | Sample 2 |
|---|---|---|
| Mesh Aperture | % Mass Powder | % Mass Powder |
| 0 | 1.39 | 3.28 |
| 90 | 0.85 | 2.25 |
| 106 | 7.91 | 19.09 |
| 212 | 7.48 | 14.26 |
| 300 | 14.31 | 20.17 |
| 425 | 9.17 | 8.94 |
| 500 | 11.35 | 8.46 |
| 600 | 22.18 | 10.28 |
| 850 | 11.32 | 3.08 |

In each molding run, a hollow plastic cube was produced using a ROTOSPEED® rotational molding machine having an aluminium cube mold with a central vent port as described in Examples 1-6. The shot weight was set at 3.0 kg. The mold was removed from the oven at the indicated internal air and oven temperatures, cooled, and the rotomolded cube removed from the mold. The following conditions were used in Comparative Example 5:

Copolyester sample (I.V.=0.75 dL/g)

Shot weight of 3.0 kg

Preheated mold

Initial oven set point 100° C. (by keeping oven doors open)

Rotation ratio 1:4

138 kPa pressure applied at 123° C.

No delayed cooling

The oven set points are shown below in Table 16. The mold was a removed from the oven at 200° C. at a peak internal air temperature of 216° C. The cycle lasted for 62 minutes. The molded cube had a yellow color, was brittle, and could only be removed from the mold in pieces.

TABLE 16
Temperature Profile for Comparative Example 5

| Oven Set Point | Time |
|---|---|
| (° C.) | (Minutes) |
| 100 | 5 |
| 150 | 5 |
| 180 | 5 |
| 250 | 5 |
| 290 | 20 |

The following conditions were used in Comparative Example 6:

Copolyester Sample 2 (I.V.=0.62 dL/g)

Shot weight of 3.0 kg

Preheated mold

Initial oven set point 150° C.

Rotation ratio 4:1

138 kPa pressure applied at 105° C.

Gas circulation volume 6000 cubic feet/min

The oven set points are shown in Table 17 below.

TABLE 17
Temperature Profile for Comparative Example 6

| Oven Set Point (° C.) | Time (Minutes) |
|---|---|
| 150 | 5 |
| 200 | 5 |
| 230 | 5 |
| 290 | 5 |
| 340 | 20 |

The mold was a removed from the oven at 245° C., delayed cooling was used for 14 minutes and a peak internal air temperature of 271° C. obtained. The cycle lasted for 95 minutes. The molded article had a yellow color, was brittle, and could only be removed from the mold in pieces.

We claim:

1. A process for rotational molding, comprising:
(a) introducing a thermoplastic polyester into a mold, wherein said polyester is a random copolymer having a crystallization half time of at least 10 minutes and an inherent viscosity of 0.55 to 0.70 deciliters/gram (dL/g), wherein said crystallization half time is measured from the molten state using a differential scanning calorimeter (DSC) by heating a 15.0 mg sample of said polyester in an aluminum pan to 290° C. at a rate of 320° C. per minute for 2 minutes, cooling said sample to the isothermal crystallization temperature at a rate of 320° C. per minute in the presence of helium and determining the time span from reaching the isothermal crystallization temperature to the point of a crystallization peak on the DSC curve; and
(b) rotating said mold at a peak internal air temperature of 150 to 255° C.

2. The process of claim 1 wherein said polyester comprises (i) diacid residues comprising at least 80 mole percent, based on the total moles of diacid residues, of one or more residues of: terephthalic acid, naphthalenedicarboxylic acid, 1,4-cyclohexanedicarboxylic acid, or isophthalic acid; and (ii) diol residues comprising 10 to 100 mole percent, based on the total moles of diol residues, of one or more residues of 1,4-cyclohexanedimethanol, neopentyl glycol, or diethylene glycol; and 0 to 90 mole percent of one or more residues of: ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, or polyalkylene glycol.

3. The process of claim 2 wherein said diol residues comprise 10 to 100 mole percent of the residues of 1,4-cyclohexanedimethanol and 0 to 90 mole percent of the residues of ethylene glycol.

4. The process of claim 2 wherein said diacid residues further comprise 0 to 20 mole percent of one or more residues of modifying diacids containing 4 to 40 carbon atoms.

5. The process of claim 4 wherein said modifying diacid comprises one or more of: succinic acid, glutaric acid, adipic acid, suberic acid, sebacic acid, azelaic acid, dimer acid, or sulfoisophthalic acid.

6. The process of claim 5 wherein said polyester further comprises one or more antioxidants, melt strength enhancers, chain extenders, flame retardants, fillers, dyes, colorants, pigments, nanoclays, antiblocking agents, flow enhancers, impact modifiers, antistatic agents, processing aids, mold release additives, or plasticizers.

7. The process of claim 6 wherein said chain extender comprises 0.05 wt % to 2 wt %, based on the total weight of said polyester, of one or more compounds selected from carbonyl bis(caprolactam), bis(oxazoline), diepoxides, diisocyanates, and carboxylic diacid anhydrides.

8. The process of claim 6 wherein said mold release additive comprises 0.05 wt % to 5 wt %, based on the total weight of said polyester, of one or more compounds selected from fatty acid amides, metal salts of organic acids, fatty acids, fatty acid salts, fatty acid esters, hydrocarbon waxes, ester waxes, phosphoric acid esters, chemically modified polyolefin waxes, fluoropolymers, glycerin esters, talc, and acrylic copolymers.

9. The process of claim 8 wherein said mold release additive comprises one or more of: erucylamide, stearamide, calcium stearate, zinc stearate, stearic acid, montanic acid, montanic acid esters, montanic acid salts, oleic acid, palmitic acid, paraffin wax, polyethylene waxes, polypropylene waxes, carnauba wax, glycerol monostearate, or glycerol distearate.

10. The process of claim 6 wherein said antioxidant comprises one or more compounds selected from phenols, phosphites, phosphonites, and sulfides.

11. The process of claim 5 wherein said crystallization half time of said polyester is at least 12 minutes.

12. The process of claim 5 wherein said polyester comprises particles and is in the form of a powder, granules, microspheres, or pellets.

13. The process of claim 12 wherein said polyester has a particle size distribution in which at least 99 weight percent of said particles are 1000 microns (μ) or less in diameter as measured by ASTM Method D1921, wherein said weight percent is based on the total weight of said particles.

14. The process of claim 13 wherein said polyester has a particle size distribution in which at least 70 weight percent of said particles are 500 microns (μ) or less in diameter as measured by ASTM Method D1921, wherein said weight percent is based on the total weight of said particles.

15. The process of claim 13 wherein said mold is maintained at a absolute pressure of 50 to 700 kilopascals (kPa) during all or a portion of step (b).

16. The process of claim 13 wherein said process is conducted in the presence of an inert gas.

17. The process of claim 13 further comprising (c) cooling said mold with a chilled gas.

18. The process of claim 13 wherein said mold has a polished surface or a surface coated with a fluoropolymer.

19. The process of claim 13 further comprising coating said mold with a mold release additive prior to step (a).

20. The process according to claim 1 wherein said polyester comprises particles in the form of a powder, granule, microspheres, or pellets and has a particle size distribution wherein at least 70 weight percent of said particles are 500 microns (μm) or less in diameter as measured by ASTM Method D1921; said polyester has a crystallization half time from a molten state of at least 15 minutes, an inherent viscosity of 0.55 to 0.70 dL/g, and comprises:
(a) diacid residues comprising at least 90 mole percent, based on the total moles of diacid residues, of one or more residues of: terephthalic acid, naphthalenedicarboxylic acid, 1,4-cyclohexanedicarboxylic acid, or isophthalic acid; and
(b) diol residues comprising 20 to 70 mole percent, based on the total moles of diol residues, of one or more residues of: 1,4-cyclohexanedimethanol, neopentyl glycol, or diethylene glycol; and 30 to 80 mole percent of the residues of one or more diols selected from ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol.

21. The process of claim 20 wherein said crystallization half time of said polyester is at least 20 minutes and said mold is maintained at an absolute pressure of 50 to 700 kilopascals (kPa) during all or a portion of step (b).

22. The process of any one of claim 21 further comprising introducing an additional thermoplastic polymer into said mold and rotating said mold at a peak internal air temperature greater than the melting point of said thermoplastic polymer before step (a) or after step (b).

23. The process of claim 22 wherein said additional thermoplastic polymer comprises one or more polymers selected from polyolefins, polyesters, polycarbonates, polyvinyl chlorides, polyamides, and combinations thereof.

24. (canceled)

25. A hollow article prepared by the process of any one of claims 1, 5, 7, 15, 18 and 23.

26. A hollow article, comprising: a thermoplastic polyester having a crystallization half time from a molten state of at least 15 minutes and an inherent viscosity of 0.55 to 0.70 dL/g, wherein said crystallization half time is measured from the molten state using a differential scanning calorimeter (DSC) by heating a 15.0 mg sample of said polyester in an aluminum pan to 290° C. at a rate of 320° C. per minute for 2 minutes, cooling said sample to the isothermal crystallization temperature at a rate of 320° C. per minute in the presence of helium and determining the time span from reaching the isothermal crystallization temperature to the point of a crystallization peak on the DSC curve, and wherein said polyester is a random copolymer comprising
(i) diacid residues comprising at least 90 mole percent, based on the total moles of diacid residues, of one or more residues of: terephthalic acid, naphthalenedicarboxylic acid, 1,4-cyclohexanedicarboxylic acid, or isophthalic acid; and
(ii) diol residues comprising 10 to 100 mole percent, based on the total moles of diol residues, of one or more residues of: 1,4-cyclohexanedimethanol, neopentyl glycol, or diethylene glycol; and 0 to 90 mole percent of one or more residues of diols selected from ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol;
wherein said hollow article is prepared by a rotational molding process.
